(19) United States
(12) Patent Application Publication
(10) Pub. No.: US 2026/0154194 A1
(43) Pub. Date: Jun. 4, 2026

(54) ACCESS FREQUENCY BASED NAND FLASH MEMORY REMAPPING METHOD AND APPARATUS SUPPORTING THE SAME

(71) Applicant: SOGANG UNIVERSITY RESEARCH & BUSINESS DEVELOPMENT FOUNDATION, Seoul (KR)

(72) Inventors: Sung Ju RYU, Seoul (KR); Jang Ho Baik, Gyeonggi-do (KR)

(73) Assignee: SOGANG UNIVERSITY RESEARCH & BUSINESS DEVELOPMENT FOUNDATION, Seoul (KR)

(21) Appl. No.: 19/351,446

(22) Filed: Oct. 7, 2025

(30) Foreign Application Priority Data
Oct. 11, 2024 (KR) 10-2024-0138313
Aug. 21, 2025 (KR) 10-2025-0116678

(51) Int. Cl. G06F 12/02

(52) U.S. Cl. CPC G06F 12/0246; G06F 2212/7206

(57) ABSTRACT

An access frequency-based NAND flash memory remapping apparatus according to an embodiment of the present disclosure includes: a data access frequency analysis unit configured to analyze an access frequency of a memory area in which at least one target information is stored; a data remapping unit configured to construct a page including the target information based on the analyzed access frequency; and a page buffer configured to store the constructed page and load it in response to an access request.

### CROSS-REFERENCE TO RELATED APPLICATION

This application claims the benefit under 35 U.S.C. § 119(a) of Korean Patent Application Nos. 10-2024-0138313, filed Oct. 11, 2024, and 10-2025-0116678 filed Aug. 21, 2025, the entire disclosures of which are incorporated herein by reference for all purposes.

### BACKGROUND

### 1. Field

The present disclosure relates to a method of remapping NAND flash memory based on access frequency, and to a device that supports the method.

### 2. Description of Related Art

In personalized recommendation systems, which must increasingly process massive amounts of user data in real time, sparse data access patterns often lead to inefficient memory access, thereby degrading overall system performance.

Conventional systems based on DRAM or NAND flash memory face inherent limitations in efficiently handling irregular access patterns because of bottlenecks that occur during the transfer of data from memory to the processor. Furthermore, in recommendation systems, only a small fraction of the embedding vectors loaded into the page buffer are actually utilized, while most remain unused. This results in wasted internal memory bandwidth, inefficient use of data center hardware resources, increased power consumption, and longer system processing latency.

### SUMMARY

The present disclosure addresses the foregoing problems by providing an access frequency-based NAND flash memory remapping method and an apparatus supporting the same. The method employs a data remapping technique that concentrates data on specific NAND flash pages according to access frequency and a page-wise cache that supports rapid access to frequently accessed data, thereby maximizing utilization of internal memory bandwidth, improving data processing efficiency, reducing processing latency, and reducing power consumption to lower overall energy consumption.

The objectives of the present disclosure are not limited to those mentioned above, and additional objectives will be readily understood by those skilled in the art from the following description.

In one general aspect, an access frequency-based NAND flash memory remapping apparatus according to an embodiment of the present disclosure includes: a data access frequency analysis unit configured to analyze an access frequency of a memory area in which at least one piece of target information is stored; a data remapping unit configured to construct a page including the target information based on the analyzed access frequency; and a page buffer configured to store the constructed page and load the page upon an access request.

The page may be configured to allow access to the target information through a single page read operation in a selective read mode.

The data access frequency analysis unit may analyze the access frequency of the memory area based on a hash table.

The data access frequency analysis unit may redistribute the target information into a page of a plane distributed in a balanced manner across planes of the memory area in accordance with the access frequency.

The access frequency-based NAND flash memory remapping apparatus may further include a page-wise cache that performs page-level caching by storing redistributed target information based on a Least Recently Used (LRU) policy.

The access frequency-based NAND flash memory remapping apparatus may further include a data processing unit that performs embedding vector operations based on the target information loaded into the page buffer.

The data remapping unit may sort the target information based on ranks according to access frequency and cluster information belonging to an access rank category into a single page. The access rank category may be defined by a predefined access frequency threshold.

In another general aspect, an access frequency-based NAND flash memory remapping method according to an embodiment of the present disclosure includes: analyzing an access frequency of a memory area in which at least one piece of target information is stored in NAND flash memory; constructing a page including the target information based on the analyzed access frequency; and loading the constructed page including the target information into a page buffer of a plane in which the target information is stored.

The constructing of a page may include arranging the target information in a consecutive address region within a same page such that the target information is accessible through only a single page read operation in a selective read mode.

The analyzing of an access frequency may include analyzing an access frequency determined by analyzing a number of accesses to each entry of the memory area based on a hash table.

The access frequency-based NAND flash memory remapping method may further include redistributing the target information into a page of a plane distributed in a balanced manner across planes of the memory area in accordance with the access frequency.

The access frequency-based NAND flash memory remapping method may further include performing page-level caching for prioritized high-speed access of the target information based on the analyzed access frequency, by storing redistributed target information based on a Least Recently Used (LRU) policy.

The access frequency-based NAND flash memory remapping method may further include performing embedding vector operations based on the target information loaded into the page buffer.

The constructing of the page may include sorting the target information based on ranks according to the access frequency; and clustering information belonging to an access rank category into a single page. The access rank category may be defined by a predefined access frequency threshold.

According to the present disclosure, by employing a data remapping technique that enables efficient use of memory through concentrating data on specific NAND flash pages according to access frequency, together with a page-wise cache that supports rapid access to frequently accessed data, the utilization of internal memory bandwidth can be maximized, the efficiency of data processing can be improved, and power consumption can be reduced to lower overall energy consumption.

In addition, various other effects that are directly or indirectly understood from this specification may also be provided.

### BRIEF DESCRIPTION OF THE DRAWINGS

FIG. 1 is a block diagram illustrating an access frequency-based NAND flash memory remapping apparatus according to an embodiment of the present disclosure.

FIG. 2 is an exemplary diagram illustrating baseline mapping in NAND flash memory according to the related art.

FIG. 3 is an exemplary diagram illustrating access frequency-based NAND flash memory remapping according to an embodiment of the present disclosure.

FIG. 4 is an exemplary diagram illustrating access frequency-based NAND flash memory remapping according to an embodiment of the present disclosure.

FIG. 5 is an exemplary diagram illustrating access frequency-based NAND flash memory remapping according to an embodiment of the present disclosure.

FIG. 6 is a block diagram illustrating an access frequency-based NAND flash memory remapping apparatus according to another embodiment of the present disclosure.

FIG. 7 is a flowchart illustrating an access frequency-based NAND flash memory remapping method according to an embodiment of the present disclosure.

FIG. 8 is an exemplary diagram illustrating layer dimensions of each Recommendation Model for Comparison (RMC) applied to a recommendation system according to the related art.

FIG. 9 is an exemplary diagram illustrating access frequency-based NAND flash memory remapping with selective read applied according to an embodiment of the present disclosure.

FIG. 10 is an exemplary diagram illustrating a comparison of embedding operation times in a recommendation system when an access frequency-based NAND flash memory remapping apparatus according to an embodiment of the present disclosure is applied.

FIG. 11 is an exemplary diagram illustrating a comparison of energy consumption for page read operations in embedding computations in a recommendation system when an access frequency-based NAND flash memory remapping apparatus according to an embodiment of the present disclosure is applied.

FIG. 12 is an exemplary diagram illustrating a comparison of inference times using synthetic datasets in a recommendation system when an access frequency-based NAND flash memory remapping apparatus according to an embodiment of the present disclosure is applied.

FIG. 13 is an exemplary diagram illustrating a comparison of inference times using real datasets in a recommendation system when an access frequency-based NAND flash memory remapping apparatus according to an embodiment of the present disclosure is applied.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness, noting that omissions of features and their descriptions are also not intended to be admissions of their general knowledge.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment, e.g., as to what an example or embodiment may include or implement, means that at least one example or embodiment exists where such a feature is included or implemented, while all examples are not limited thereto.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

The features of the examples described herein may be combined in various ways as will be apparent after an understanding of the disclosure of this application. Further, although the examples described herein have a variety of configurations, other configurations are possible as will be apparent after an understanding of the disclosure of this application.

A detailed description is given below, with reference to attached drawings.

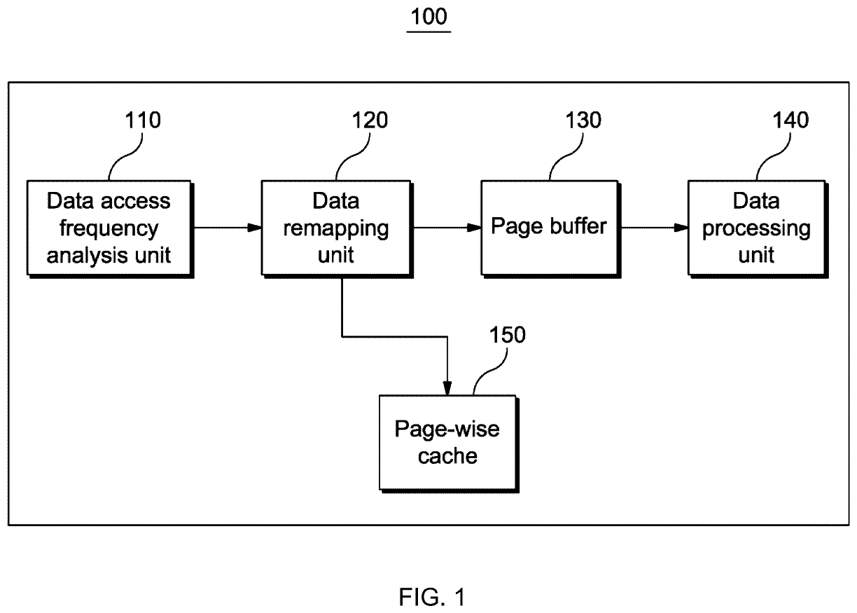

FIG. 1 is a block diagram illustrating an access frequency-based flash memory remapping apparatus according to an embodiment of the present disclosure.

Referring to FIG. 1, an access frequency-based flash memory remapping apparatus 100 according to an embodiment of the present disclosure includes a data access frequency analysis unit 110 configured to analyze an access frequency of a memory area in which at least one target piece of information is stored, a data remapping unit 120 configured to construct a page including the target information based on the analyzed access frequency, and a page buffer 130 configured to store the constructed page and to load the page upon an access request.

A NAND flash memory is a non-volatile storage medium capable of storing data without a power supply, and provides high density, low cost, and high durability for data storage. It is particularly suitable for processing large-scale data and generally has the following configuration:

### 1) Nand Flash Memory Array

A NAND flash memory array is a basic storage unit that includes a plurality of memory cells within a NAND flash chip. Each cell is capable of storing multiple bits of data, and the cells are arranged to form pages, blocks, and planes. A cell is a fundamental storage unit implemented as a floating-gate transistor that stores data by trapping electrons in the gate.

### 2) Page

A page is the smallest read/write unit in NAND flash memory, and typically stores 4 to 32 kilobytes (KB) of data.

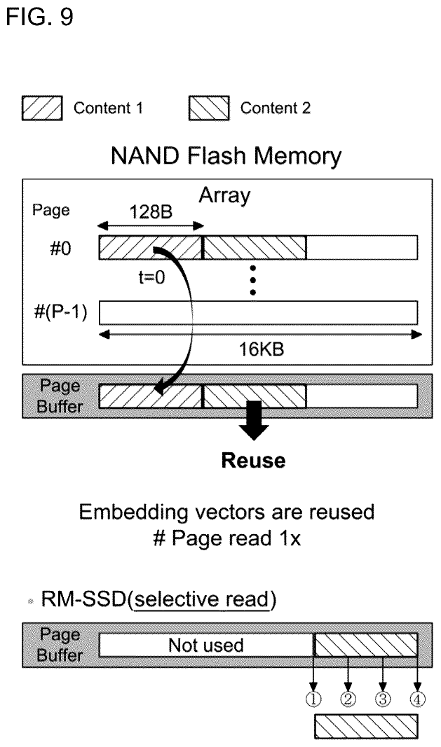

As illustrated in FIG. 9, a page may be configured to allow access to target information through a single-page read operation using a selective read method, or through a sequential read method. In recommendation systems, however, because computations in embedding layers involve irregular memory access, the selective read method is more advantageous and may therefore be preferentially adopted.

### 3) Block

A block is a unit formed by a plurality of pages, and is the smallest erase unit in flash memory. In NAND flash memory, data is erased or overwritten on a block basis.

### 4) Plane

A plane is a unit formed by a plurality of blocks. A NAND flash memory typically includes multiple planes, and each plane can operate independently to enable parallel data processing.

### 5) Die

A die is an independent operating unit of flash memory, and each die includes multiple planes. Data processing in NAND flash memory is performed on a die basis.

### 6) Controller

A controller is a component that processes commands when data is read from or written into NAND flash memory.

### 7) Page Buffer

A page buffer is a temporary storage unit for data. Data stored in the page buffer may subsequently be moved to another memory or transmitted to a CPU. A page buffer is allocated to each plane, enabling independent data processing while temporarily holding data. A page buffer may also store a constructed page and load the page upon an access request.

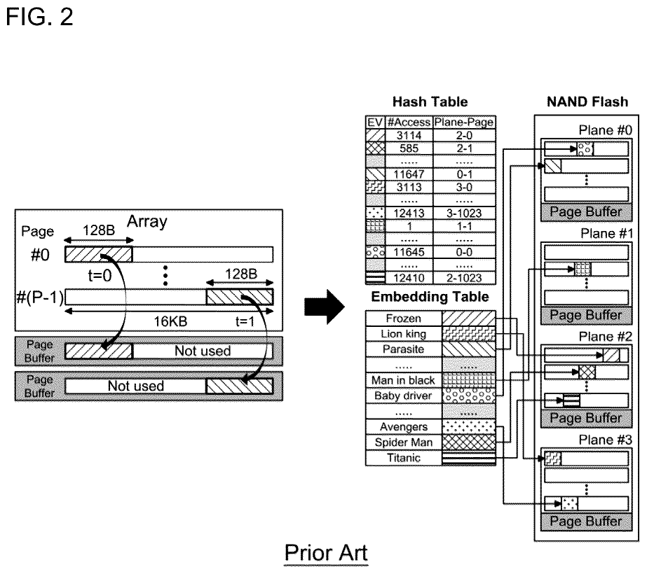

As illustrated in FIG. 2, a conventional memory array of NAND flash memory is composed of small units called pages. Each page has a fixed size (for example, 16 kilobytes), and the stored information in the page is loaded into a page buffer. For example, at each time unit, the page buffer loads data of a specific page (e.g., page #0 and page #(P-1)). However, as illustrated in FIG. 2, a significant portion of the page data loaded into the page buffer is not actually used, thereby wasting the buffer. In other words, as illustrated in FIG. 2, only a small portion of the page buffer contains data that is actually needed, while most of the remaining space stores unnecessary data, resulting in wasted memory bandwidth and storage space. Such waste of the page buffer reduces memory read/write efficiency and negatively affects overall system performance.

Meanwhile, the above-described personalized recommendation system (hereinafter referred to as a “recommendation system”) is a system that provides personalized suggestions by analyzing a user's previous activities, preferences, and behavior patterns. It serves as a powerful tool for personalized recommendations by analyzing a user's experiences and preferences such as video streaming history, click counts in over-the-top (OTT) media services, and social network connections. For example, various e-commerce companies have used recommendation systems to recommend products suitable for customers and thereby promote sales, while video service and social networking service providers have used them to provide personalized content suggestions based on user history, thereby improving user satisfaction and increasing revenue.

In such a recommendation system, NAND flash memory is used to enhance performance in terms of data storage efficiency, access speed, and system scalability. Specifically, since a recommendation system must process large volumes of user data and content information to provide personalized content to users, complex data analysis and processing are required, and NAND flash memory plays the following roles in such processes:

### (1) Large-Scale Data Storage

A recommendation system needs to store massive amounts of data including a user's past behaviors, preferences, and interaction records. NAND flash memory is a high-density storage medium that can store large amounts of data at relatively low cost. As such, it allows a data center to efficiently use physical space while still enabling quick access to all data required by the recommendation system.

### (2) Fast Data Access

A recommendation system requires fast data read speeds to respond quickly to user requests. NAND flash memory provides faster read and write speeds than conventional hard disk drives (HDDs), making it suitable for delivering services without delay. In addition, since recommendation systems frequently need to analyze and update user data in real time, the fast data processing capability of NAND flash memory becomes even more important.

### (3) Scalability and Flexibility

In general, recommendation systems are operated on cloud-based services or large-scale data centers, and thus the data storage must be easily scalable depending on increases or decreases in users. NAND flash memory occupies relatively little physical space while providing high data transfer speeds, allowing additional storage requirements to be easily integrated and thereby facilitating system scalability.

### (4) Energy Efficiency

A significant portion of the operating cost of data centers that run recommendation systems is related to energy consumption. NAND flash memory is an energy-efficient storage medium capable of reducing power consumption while maintaining necessary performance.

Through the use of NAND flash memory in recommendation systems as described above, the performance, cost efficiency, and operational flexibility of recommendation systems can be improved.

As illustrated in FIG. 2, in the operation of NAND flash memory in a conventional recommendation system, the physical storage location of data is determined through a hash table that records the number of accesses to each embedding vector (i.e., a vector in which features of content such as a movie title are converted into numerical values) and the plane-page information in which the vector is stored. The stored data is sequentially stored in the order of pages within each plane. In this case, although page-level data is stored in the page buffer of each plane, only a very small portion of the data is actually needed, and consequently, a large portion of the page-level data stored in the page buffer remains unused, lowering memory efficiency.

The embedding layer of the recommendation system exhibits irregular memory access patterns. As a result, only a very small portion of the data in the page buffer is selectively used, while the rest is not utilized. The required data is distributed discontinuously, leading to a very low data reuse rate in the page buffer. In addition, frequently accessed data is scattered across different planes and pages, which prevents uniform utilization of the page buffers of the respective planes. Consequently, due to the irregular memory access of conventional recommendation systems, the page buffers of planes show low data reuse rates, and the page buffers of the respective planes are utilized inefficiently, which can reduce the overall memory bandwidth of the system.

To address these problems, an access frequency-based flash memory remapping apparatus 100 according to an embodiment of the present disclosure operates the page buffer in NAND flash memory based on access frequency information with respect to target information (e.g., a movie or music to be recommended) when making recommendations. For this purpose, a data access frequency analysis unit 110 of the access frequency-based flash memory remapping apparatus 100 analyzes an access frequency of a memory area in which at least one target piece of information is stored.

In an embodiment, the data access frequency analysis unit 110 may sort a hash table according to access frequency of target information (e.g., movies or music to be recommended). In an embodiment, the data access frequency analysis unit 110 may analyze the access frequency of a memory area based on the hash table.

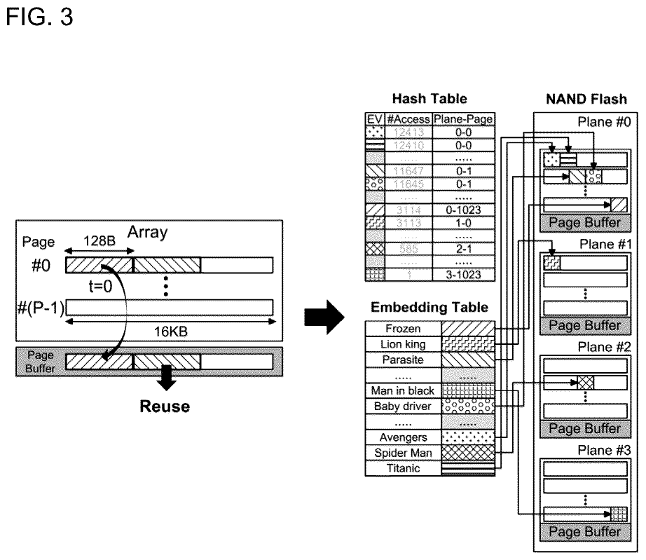

A data remapping unit 120 of the access frequency-based flash memory remapping apparatus 100 may rearrange target information (or embedding vectors of target information) by changing planes and pages for high-speed access based on the analyzed access frequency of the memory area. For example, as illustrated in FIG. 3, the data remapping unit 120 according to an embodiment may sequentially distribute embedding vectors of target information across multiple planes according to the access frequency of a hash table sorted by access frequency.

A page buffer 130 of the access frequency-based flash memory remapping apparatus 100 stores target information (or embedding vectors of target information) distributed by the data remapping unit 120 according to an embodiment. The page buffer 130 according to an embodiment may store the constructed page and load the page upon an access request.

The hash table contains information on the access frequency of target information and the plane and page locations in which the target information is allocated. An embedding table is a table in which categorical features of a particular item (e.g., a recommended content title) are mapped from a high-dimensional categorical space to a low-dimensional continuous vector space. A converted vector is called an embedding vector, which numerically represents the features of the corresponding item.

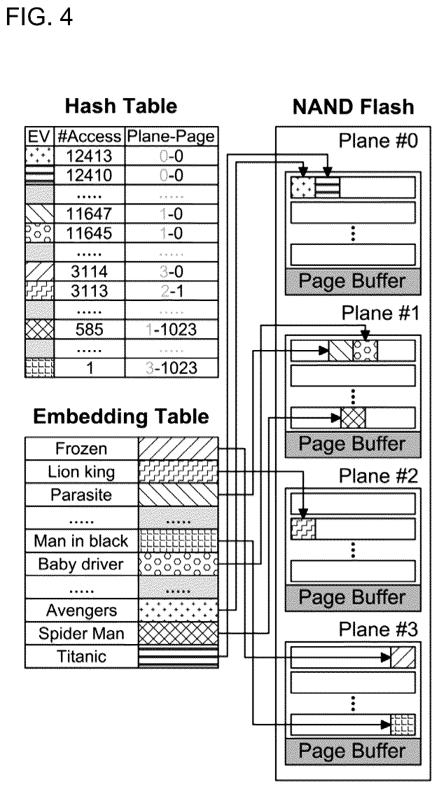

As illustrated in FIG. 4, the data remapping unit 120 of the access frequency-based flash memory remapping apparatus 100 according to an embodiment may distribute embedding vectors of target information across multiple planes in a balanced manner according to the access frequency of a hash table sorted by access frequency. That is, the data remapping unit 120 according to an embodiment may place a predetermined number of target information (or embedding vectors of target information) to each plane and then move to the next plane to place additional target information. In this way, target information can be cyclically distributed across all planes to maintain balance among the planes. The target information (or embedding vectors of target information) distributed in this manner is placed in the page buffer 130 of the corresponding plane.

In addition, the data remapping unit 120 according to an embodiment may sort target information based on a rank determined according to access frequency and may cluster information belonging to the same access rank category into a single page. In this case, the same access rank category may be set by a predefined access frequency threshold. That is, the data remapping unit 120 according to an embodiment may sort target information according to how frequently it is accessed and may group information with similar access frequencies into a single flash page (where the criterion of “similar access frequency” can be distinguished by a predefined threshold).

Further, the data remapping unit 120 according to an embodiment may sort target information based on a rank determined according to access frequency and may cluster only target information whose access frequency is above a predefined threshold into a single page. In large-scale personalized recommendation services, if all target information were to be remapped based on access frequency, overhead may become excessive. Therefore, only high-frequency target information may be remapped.

The access frequency-based flash memory remapping apparatus 100 according to an embodiment may further include a data processing unit 140 configured to read the target information loaded into the page buffer.

In addition, the access frequency-based flash memory remapping apparatus 100 according to an embodiment may further include a page-wise cache 150 based on a Least Recently Used (LRU) policy to store redistributed target information. The page-wise cache tracks access times of data stored in each page and updates the access time each time the data is accessed. The page-wise cache 150 may use this information to determine which data is to be removed from the cache.

The page-wise cache 150 according to an embodiment removes from the cache the page that has not been used for the longest time based on the LRU policy and replaces it with new data. Such an LRU-based page cache allows frequently accessed data to remain in the cache in systems where frequent data access is required, thereby reducing memory access time and improving overall system response speed. The page-wise cache 150 according to an embodiment may be implemented as static random access memory (SRAM) for high-speed data processing and fast access.

Additionally, the access frequency-based NAND flash memory remapping apparatus 100 according to an embodiment may perform the following additional techniques to further enhance performance of a recommendation system by promoting efficient use of storage space, faster data processing, and overall system optimization. Specifically, when remapping data using the above-described method, the data remapping unit 120 according to an embodiment may apply a data compression technique to perform the remapping.

In addition, when reading target information loaded into the page buffer, the data processing unit 140 according to an embodiment may introduce multi-threading and/or parallel processing techniques to distribute computational load required for processing large-scale datasets and to improve processing speed. The data processing unit 140 according to an embodiment may also perform embedding vector operations based on the target information loaded into the page buffer.

Further, the access frequency-based NAND flash memory remapping apparatus 100 according to an embodiment may further include a performance monitoring unit configured to monitor system performance. The performance monitoring unit according to an embodiment may monitor system performance in real time based on metadata generated during data processing (e.g., access frequency, processing time, compression ratio, etc.), and may perform optimization measures as needed.

Meanwhile, although the above-described access frequency-based NAND flash memory remapping apparatus 100 has been described with respect to an application to a personalized recommendation system, it is not limited thereto and can also be applied to database management systems (DBMS), real-time analytics systems, machine learning and deep learning workloads, and various streaming services. That is, in large-scale databases, efficiently managing frequently accessed data is important, and thus the access frequency-based NAND flash memory remapping apparatus 100 according to an embodiment may improve data access speed and reduce I/O bottlenecks when index access patterns are random. In real-time analytics systems that process real-time data streams requiring fast data access and processing, the access frequency-based NAND flash memory remapping technology according to an embodiment may be utilized to effectively cache frequently used data and to improve access speed.

In addition, in machine learning and deep learning that perform large-scale matrix operations, processing-in-memory (PIM)-based systems may be used to reduce data transfer costs between memory and processors and to improve computation speed.

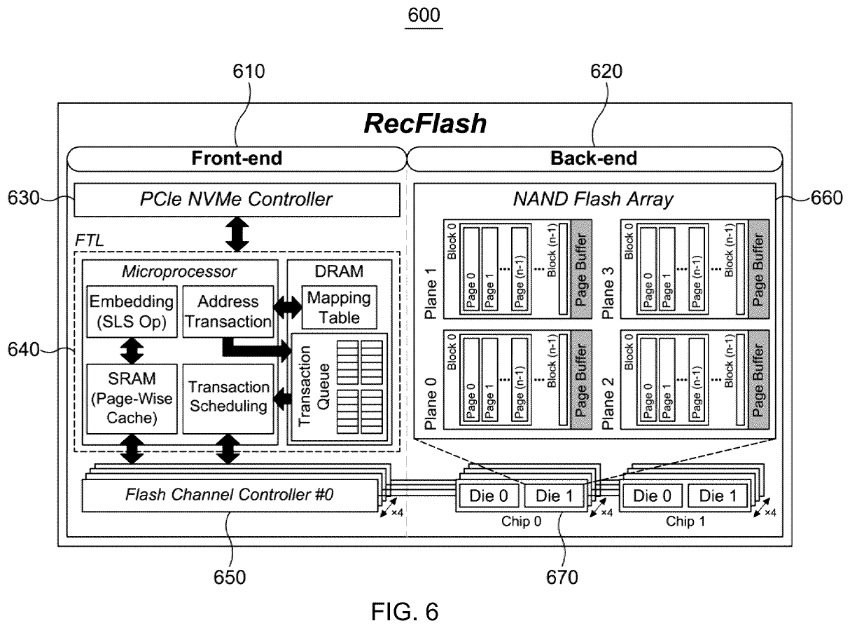

FIG. 6 is a diagram illustrating an access frequency-based flash memory remapping apparatus according to another embodiment of the present disclosure.

FIG. 6 is an exemplary diagram of a recommendation flash device (RecFlash) 600, which is a specific implementation of the access frequency-based NAND flash memory mapping apparatus 100 illustrated in FIG. 1, and is configured with a front-end 610 and a back-end 620.

In the front-end 610 of the recommendation flash device 600, a PCIe NVMe controller 630 manages data transfer between a host system and a solid-state drive (SSD).

A microprocessor and a DRAM within a flash translation layer (FTL) 640 process conversion between logical addresses and physical addresses, and the DRAM includes a mapping table for storing mapping information between the logical addresses and the physical addresses. The microprocessor also performs embedding operations and manages a transaction queue to optimize data access in NAND flash memory. In addition, an SRAM within the FTL 640 functions as the page-wise cache 150, which operates as the page buffer 130 based on a Least Recently Used (LRU) policy, storing frequently used embedding vectors to reduce the time required to read data from NAND flash memory. The page-wise cache 150 may be stored within NAND flash memory; however, a page-wise cache is implemented within the FTL 640 of the SSD controller chip while using a standard commercial NAND flash memory without modification. A flash channel controller 650 in the back-end 620 is responsible for sending commands to the memory chips and transferring data.

The back-end 620 of the recommendation flash device 600 is composed of multiple independent bus channels, each of which is connected to one or more NAND flash chips. Each chip is divided into multiple dies 670, and each die is composed of one or more planes. Each plane consists of multiple blocks, and each block consists of multiple pages. Each plane has a dedicated page buffer that temporarily stores data read from a NAND flash array 660 before transmitting the data to the SSD controller.

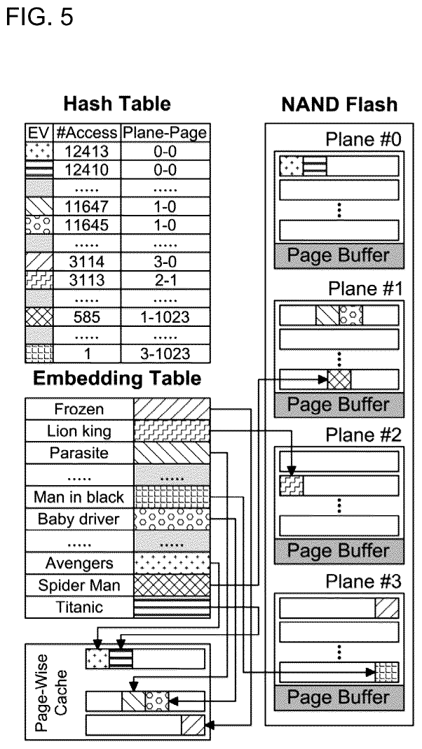

When an embedding vector whose data is required is requested, as illustrated in FIG. 5, the recommendation flash device 600 first checks whether the vector already exists in the page-wise cache 150. If the data exists in the page-wise cache 150, the data is read directly from the cache, thereby reducing the time to read data from NAND flash memory. If the data does not exist in the page-wise cache 150, the data is read from the NAND flash array 660 into the page buffer, and the data is then stored in the cache to prepare for future requests.

Hereinafter, an access frequency-based NAND flash memory remapping method according to an embodiment of the present disclosure will be described based on the foregoing description.

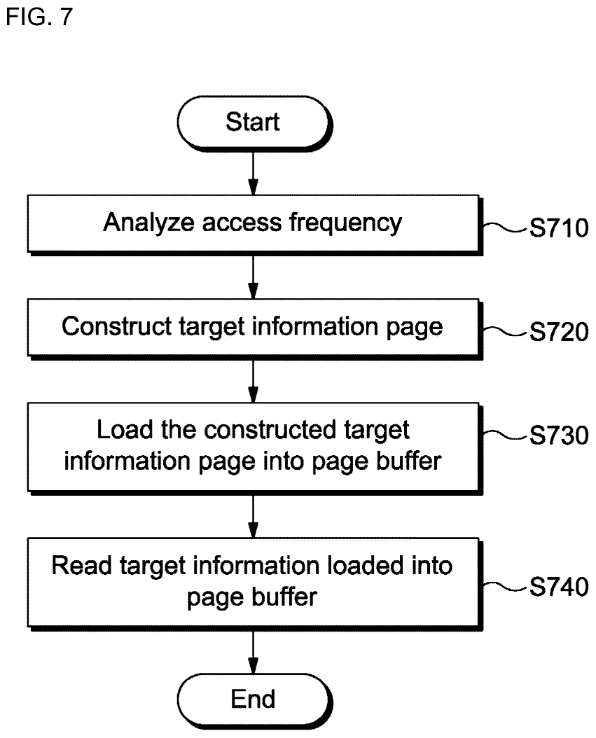

FIG. 7 is a flowchart illustrating an access frequency-based NAND flash memory remapping method according to an embodiment of the present disclosure, using the access frequency-based NAND flash memory remapping apparatus 100 of FIG. 1.

Referring to FIG. 7, the access frequency-based NAND flash memory remapping method according to an embodiment of the present disclosure includes analyzing an access frequency of a memory area in which at least one target information is stored in NAND flash memory by the data access frequency analysis unit 110 (S710).

When analyzing the access frequency of the memory area in which at least one target information is stored in NAND flash memory, the access frequency may be determined by analyzing the number of accesses to each entry of the memory area based on a hash table.

Based on the analyzed access frequency of the memory area, the data remapping unit 120 configures a page including the target information (S720), and the configured page including the target information is loaded into a page buffer of the plane in which the target information is stored (S730).

When configuring the page including the target information based on the analyzed access frequency of the memory area, the data remapping unit 120 may arrange the target information in a continuous address region within the same page so that the target information can be accessed through a single page read operation in a selective read mode.

When configuring the page including the target information based on the analyzed access frequency of the memory area, the data remapping unit 120 may also sort the target information based on a rank according to the access frequency, and may cluster information belonging to the same access rank category into a single page. In this case, the same access rank category may be set by a predefined access frequency threshold.

In addition, based on the analyzed access frequency of the memory area, the data remapping unit 120 may redistribute the target information into pages for high-speed access.

In this case, when redistributing the target information into pages for high-speed access based on the analyzed access frequency of the memory area, the data remapping unit 120 may sequentially redistribute the target information into pages of the memory area according to access frequency, as illustrated in FIG. 3.

Alternatively, when redistributing the target information into pages for high-speed access based on the analyzed access frequency of the memory area, the data remapping unit 120 may redistribute the target information into pages of planes allocated according to balanced distribution across planes based on access frequency, as illustrated in FIG. 4.

The data processing unit 140 reads the target information loaded into the page buffer (S740). The data processing unit 140 may perform embedding vector operations based on the target information loaded into the page buffer.

In addition, the access frequency-based NAND flash memory remapping apparatus 100 according to an embodiment may further place the target information into a cache memory (page-wise cache 150) for top-priority high-speed access based on the analyzed access frequency of the memory area. The access frequency-based NAND flash memory remapping apparatus 100 according to an embodiment may perform page-wise caching by storing redistributed target information based on a Least Recently Used (LRU) policy for top-priority high-speed access.

For example, when an embedding vector whose data is required is requested, the access frequency-based NAND flash memory remapping apparatus 100 first checks whether the corresponding vector already exists in the page-wise cache 150. If the data exists in the page-wise cache 150, the data is read directly from the page-wise cache, thereby reducing the time to read data from NAND flash memory. If the data does not exist in the page-wise cache 150, the data is read from the NAND flash array and loaded into the page buffer, and then the data is stored in the cache to prepare for future requests.

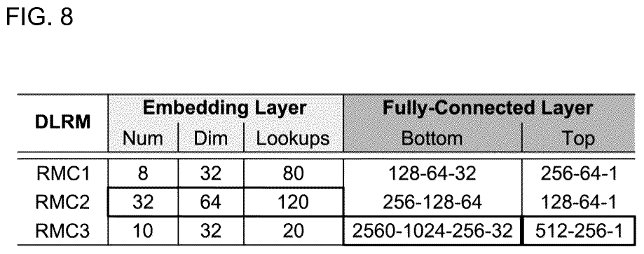

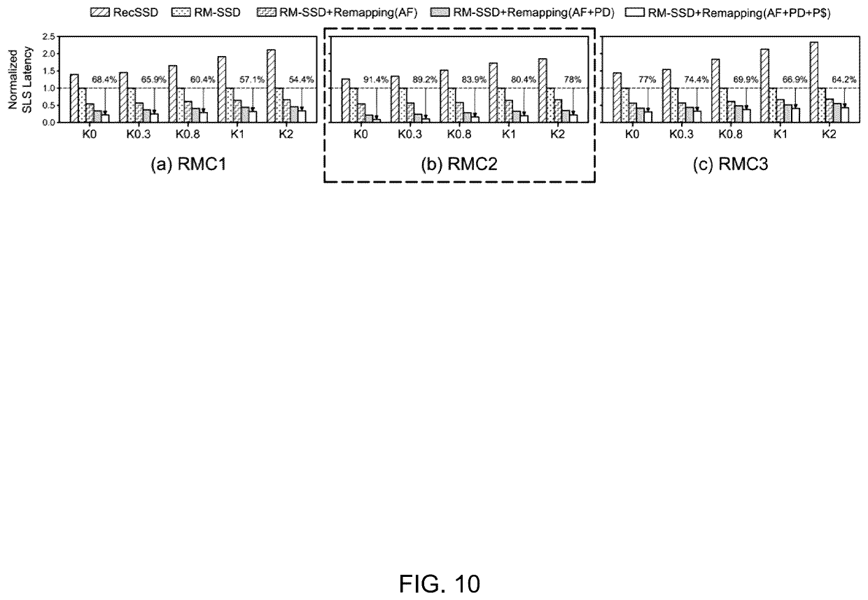

FIGS. 10 to 13 illustrate exemplary performance tests for each Recommendation Model for Comparison (RMC) when the access frequency-based NAND flash memory remapping apparatus 100 according to an embodiment of the present disclosure is applied to the conventional recommendation system of FIG. 8.

The RMC model is a series of experimental models based on the Deep Learning Recommendation Model (DLRM) used in recommendation systems. These models are generally defined as benchmark models for testing various recommendation model architectures in academic papers and patents, and may be used in particular to evaluate computational bottlenecks in recommendation systems. The DLRM model is primarily composed of an embedding layer and a fully connected (FC) layer.

In general, the embedding layer converts sparse features, such as user or item categories, into vectors and is characterized by random memory access patterns and high bandwidth consumption. The fully connected layer, by contrast, is the main source of computational bottlenecks and represents a traditional neural network layer with computation-intensive characteristics. As shown in FIG. 8, the embedding and fully connected layers of the RMC1, RMC2, and RMC3 models may be configured accordingly.

FIG. 10 shows a comparison of embedding operation times when the access frequency-based NAND flash memory remapping apparatus 100 according to an embodiment of the present disclosure is applied to a recommendation system. Synthetic datasets (K0, K0.3, K0.8, K1, K2) are used, and normalization is performed based on RM-SSD (selective read). Since RecSSD uses sequential reads, the experimental results are greater than 1.

FIG. 10 quantitatively demonstrates the extent to which access frequency-based clustering according to an embodiment of the present disclosure can accelerate embedding operations. As shown in FIG. 10, the access frequency-based NAND flash memory remapping apparatus 100 achieves the most significant improvement with the RMC2 model, which is embedding-layer intensive.

Specifically, as the K value decreases (i.e., as the proportion of frequently accessed data increases), the performance gain becomes more pronounced. Compared with the RM-SSD baseline, computation time is reduced by up to 91.4% (K0, RMC2). In addition, cumulative performance improvements are observed from clustering (AF), plane distribution (PD), and page-wise caching (P$).

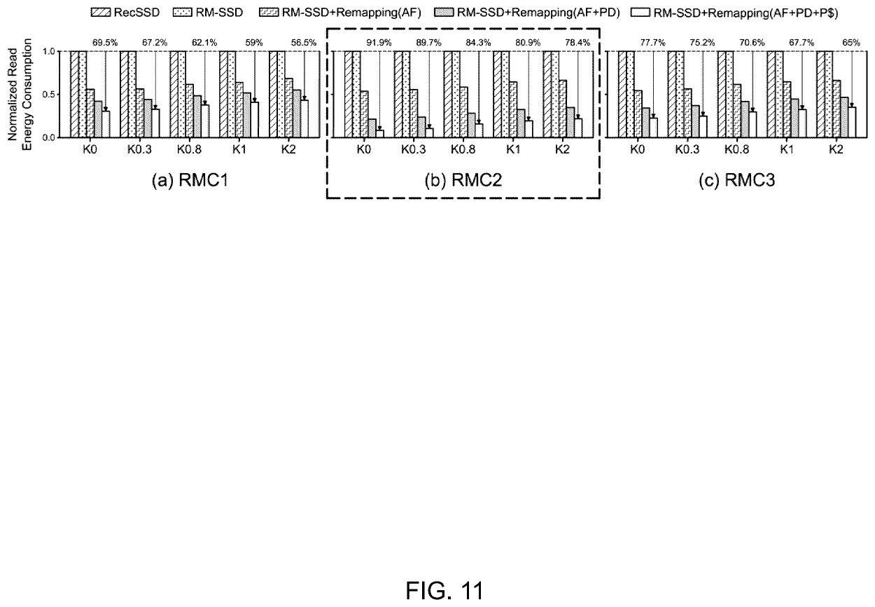

FIG. 11 is an exemplary diagram comparing energy consumption of page read operations for embedding computations when the access frequency-based NAND flash memory remapping apparatus according to an embodiment of the present disclosure is applied in a recommendation system. Synthetic datasets (K0, K0.3, K0.8, K1, K2) are used, and both RM-SSD (selective read) and RecSSD (sequential read) perform two page read operations equally, such that each experimental result is normalized to 1.

The results shown in FIG. 11 demonstrate the effectiveness of memory access optimization from the perspective of energy consumption. Specifically, the figure shows how various remapping techniques (AF, AF+PD, AF+PD+P$) implemented by the access frequency-based NAND flash memory remapping apparatus of the present disclosure improve energy efficiency compared with conventional approaches (RecSSD, RM-SSD).

As shown in FIG. 11, the proposed access frequency-based remapping technique achieves up to a 91.9% reduction in page read energy consumption relative to conventional methods. The improvement is most pronounced in the embedding-intensive RMC2 model, with the greatest performance gain observed when K0 is applied and the smallest when K2 is applied.

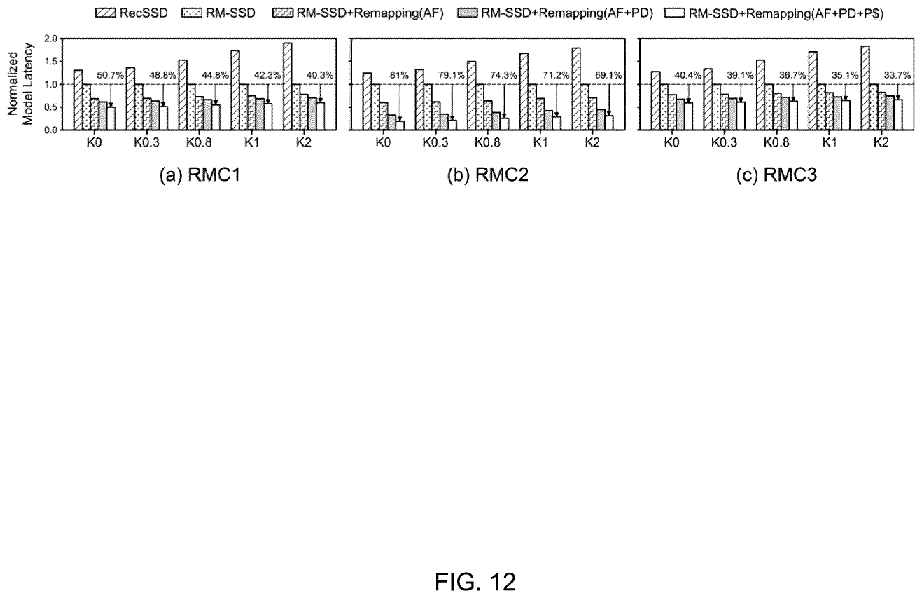

FIG. 12 is an exemplary diagram comparing inference times when the access frequency-based NAND flash memory remapping apparatus according to an embodiment of the present disclosure is applied to a recommendation system using synthetic datasets (K0, K0.3, K0.8, K1, K2).

As shown in FIG. 12, in scenarios with data access bottlenecks (embedding-heavy structures), the proposed technique reduces latency and also improves system throughput. Remapping alone provides significant benefits, and performance improves further when combined with plane distribution (PD) and cache (P$) strategies. Compared with prior approaches, the performance gain is largest with K0 and smallest with K2. Because inference time is measured for the entire model, performance improvement is greatest with the RMC2 model and smallest with the RMC3 model.

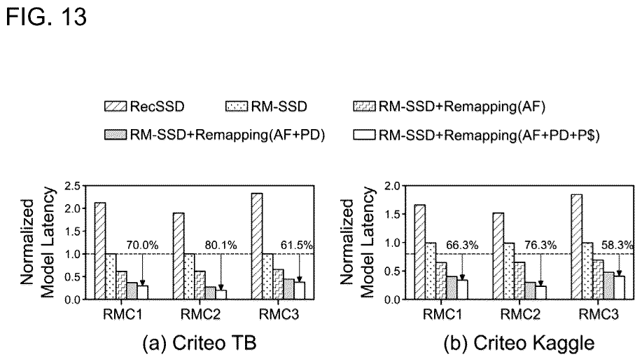

FIG. 13 illustrates a comparison of inference times when the access frequency-based NAND flash memory remapping apparatus according to an embodiment of the present disclosure is applied to a recommendation system using real datasets, including Criteo TB and Criteo Kaggle, which are among the largest real-world datasets used in recommendation systems. The figure presents experimental results measuring the extent to which the proposed apparatus reduces end-to-end inference latency on actual recommendation system data.

As shown in FIG. 13, when applied to real datasets, the access frequency-based NAND flash memory remapping apparatus of the present disclosure achieves the greatest performance improvement on the Criteo TB dataset. Compared with prior work, the performance gain is largest with K0 and smallest with K2. Based on total inference time, an improvement of up to 80.1% is achieved, demonstrating that the proposed technique can provide significant latency reduction even in real-world recommendation systems.

As described above, the present disclosure employs a data remapping technique that enables efficient use of memory by intensively placing data in specific pages of NAND flash according to access frequency, and a page-wise cache that supports fast access to frequently accessed data, thereby maximizing the utilization of internal memory bandwidth and improving the efficiency of data processing, and thus reducing power consumption and lowering energy consumption.

The embodiments described above may be implemented using various types of computing means that include one or more processors, memory, and storage. Such computing means may also include a network interface connected to a wired or wireless network. The processor may be a central processing unit or a semiconductor device configured to execute processing instructions stored in the memory and/or storage unit. The memory and storage unit may include volatile or non-volatile storage media, and, for example, the memory may include ROM and RAM. Accordingly, embodiments of the present disclosure may be implemented as computer-implemented methods or as non-transitory computer-readable media having computer-executable instructions stored thereon. When executed by a processor, such instructions may perform the method according to at least one aspect of the present disclosure.

Although embodiments of the present disclosure have been described with reference to the accompanying drawings, these embodiments are provided for illustrative purposes only. It will be apparent to those of ordinary skill in the art that various modifications, changes, and equivalent alternatives may be made without departing from the spirit and scope of the present disclosure. For instance, the data access frequency analysis unit 110 and the data remapping unit 120 may be implemented as a single integrated module, or may be divided into two or more separate devices. Therefore, the true scope of the present disclosure should be defined by the technical spirit of the appended claims.

What is claimed is:

1. An access frequency-based NAND flash memory remapping apparatus, comprising:
a data access frequency analysis unit configured to analyze an access frequency of a memory area in which at least one piece of target information is stored;
a data remapping unit configured to construct a page including the target information based on the analyzed access frequency; and
a page buffer configured to store the constructed page and load the page upon an access request.

2. The access frequency-based NAND flash memory remapping apparatus of claim 1,
wherein the page is configured to allow access to the target information through a single page read operation in a selective read mode.

3. The access frequency-based NAND flash memory remapping apparatus of claim 1,
wherein the data access frequency analysis unit analyzes the access frequency of the memory area based on a hash table.

4. The access frequency-based NAND flash memory remapping apparatus of claim 1,
wherein the data access frequency analysis unit redistributes the target information into a page of a plane distributed in a balanced manner across planes of the memory area in accordance with the access frequency.

5. The access frequency-based NAND flash memory remapping apparatus of claim 1, further comprising:
a page-wise cache that performs page-level caching by storing redistributed target information based on a Least Recently Used (LRU) policy.

6. The access frequency-based NAND flash memory remapping apparatus of claim 1, further comprising:
a data processing unit that performs embedding vector operations based on the target information loaded into the page buffer.

7. The access frequency-based NAND flash memory remapping apparatus of claim 1,
wherein the data remapping unit sorts the target information based on ranks according to access frequency and clusters information belonging to an access rank category into a single page, and
wherein the access rank category is defined by a predefined access frequency threshold.

8. An access frequency-based NAND flash memory remapping method, comprising:
analyzing an access frequency of a memory area in which at least one piece of target information is stored in NAND flash memory;
constructing a page including the target information based on the analyzed access frequency; and
loading the constructed page including the target information into a page buffer of a plane in which the target information is stored.

9. The access frequency-based NAND flash memory remapping method of claim 8,
wherein the constructing of a page comprises arranging the target information in a consecutive address region within a same page such that the target information is accessible through only a single page read operation in a selective read mode.

10. The access frequency-based NAND flash memory remapping method of claim 8,
wherein the analyzing of an access frequency comprises analyzing an access frequency determined by analyzing a number of accesses to each entry of the memory area based on a hash table.

11. The access frequency-based NAND flash memory remapping method of claim 8, further comprising:
redistributing the target information into a page of a plane distributed in a balanced manner across planes of the memory area in accordance with the access frequency.

12. The access frequency-based NAND flash memory remapping method of claim 8, further comprising:
performing page-level caching for prioritized high-speed access of the target information based on the analyzed access frequency, by storing redistributed target information based on a Least Recently Used (LRU) policy.

13. The access frequency-based NAND flash memory remapping method of claim 8, further comprising:
performing embedding vector operations based on the target information loaded into the page buffer.

14. The access frequency-based NAND flash memory remapping method of claim 8,
wherein the constructing of the page comprises:
sorting the target information based on ranks according to the access frequency; and
clustering information belonging to an access rank category into a single page,
wherein the access rank category is defined by a predefined access frequency threshold.
